(19) United States
(12) Patent Application Publication
(10) Pub. No.: US 2012/0184653 A1
(43) Pub. Date: Jul. 19, 2012

(54) Synthesis of linear phosphorus-containing functional fluorocopolymer

(76) Inventors: Liang Wang, Acworth, GA (US); Viktoria Wang, Acworth, GA (US)

(21) Appl. No.: 12/930,807

(22) Filed: Jan. 18, 2011

(51) Int. Cl. C08F 214/26; C08F 4/00; C08K 5/101; C08F 14/24

(52) U.S. Cl. 524/315; 526/255; 526/249; 526/227

(57) ABSTRACT

This invention relates to a synthesis of a linear fluorocopolymer having a plurality of pendant phosphorus-containing functional groups. The synthesized phosphorus-containing fluorocopolymer has chain linearity and narrow molecular weight distributions. It has applications as a lubricant additive that provides friction-reduction, anti-wear, and corrosion protection properties.

### PATENT DOCUMENT

| | | | |
|---|---|---|---|
| U.S. Pat. No. 7,754,662 | Jul. 13, 2010 | Aswath, et al. | 508/181 |
| U.S. Pat. No. 7,727,651 | Jan. 1, 2010 | Kiefer, et al. | 429/492 |
| U.S. Pat. No. 7,454,487 | Nov. 18, 2008 | Konzaki | 252/500 |
| U.S. Pat. No. 7,384,996 | Jun. 10, 2008 | Taniguchi, et al. | 524/123 |
| U.S. Pat. No. 7,288,603 | Oct. 30, 2007 | Sokeguchi, et al. | 525/411 |
| U.S. Pat. No. 7,214,648 | May 8, 2007 | Saini, et al. | 508/363 |
| EP 1,265,906 | 22 Jun. 2005 | Beatty | C07F 9/165 |
| U.S. Pat. No. 6,828,284 | Dec. 7, 2004 | Howell, et al. | 508/182 |
| U.S. Pat. No. 6,764,984 | Jul. 20, 2004 | Beatty | 508/435 |
| U.S. Pat. No. 6,680,346 | Jan. 20, 2006 | Kimoto | 521/27 |
| U.S. Pat. No. 6,642,186 | Nov. 4, 2003 | Beatty | 508/154 |
| U.S. Pat. No. 6,541,430 | Apr. 1, 2003 | Beatty | 508/368 |
| U.S. Pat. No. 6,177,196 | Jan. 26, 2001 | Brothers, et al. | 428/422 |
| U.S. Pat. No. 6,110,878 | Aug. 29, 2000 | McConnachie, et al. | 508/363 |
| U.S. Pat. No. 5,969,067 | Oct. 19, 1999 | Brothers, et al. | 526/247 |
| U.S. Pat. No. 5,874,169 | Feb. 23, 1999 | Falcone | 428/421 |
| U.S. Pat. No. 5,344,580 | Sep. 6, 1994 | von Werner | 252/54 |
| U.S. Pat. No. 5,154,845 | Dec. 13, 1992 | Williams | 508/545 |
| U.S. Pat. No. 5,032,306 | Jul. 16, 1991 | Cripps | 252/68 |
| U.S. Pat. No. 4,888,122 | Dec. 19, 1989 | McCready | 508/165 |
| U.S. Pat. No. 4,806,281 | Feb. 21, 1989 | Huth | 508/182 |
| U.S. Pat. No. 4,465,607 | Aug. 14, 1984 | Cottell | 508/181 |
| U.S. Pat. No. 4,185,031 | Jan. 22, 1980 | Gillman, et al. | 562/25 |

### OTHER REFERENCES

[1] Lubricant Additives: Chemistry and Applications, Editor: Rudnick, L R, CRC Press, 2009
[2] Advances in Lubricant Additives and Tribology, by Srivastava, S P, Tech Books, 2009
[3] Well-Architectured Fluoropolymers: Synthesis, Properties and Applications, Ameduri, B. and Boutevin, B, Elsevier, 2004.
[4] Modern Fluoropolymers, High Performance Polymers for Diverse Applications, Edited by Scheirs, J, Wiley Series in Polymer Science, 1997
[5] Fluoropolymers 1: Synthesis (Topics in Applied Chemistry), V. 1, Edited by Hougham, G G, Cassidy, P E, Johns, K, Dadidson, and Kluwer, T, Academic/Pienum Publishers, 1999
[6] The Chemistry of Radical Polymerization, Second Edited by Mood G, and Solomon, D H, Elsevier Science, 2005
[7] Controlled and Living Polymerizations: From Mechanisms to Applications, Edited by Motyjaszewski, K and Muller, A H E, Wiley Vch, 2009
[8] Catalytic Polymerization of Cycloolefins: Ionic Ziegles-Natta and Ring-opening Metathesis Polymerization, Studies in Surface Science and Catalysis, Vol. 131, V. Dragutan, and R. Streck, Elsevier, 2000
[9] Daniel, T L, Biol. Bull., 160, 376-382, 1981
[10] Bushnell D M and Moore K J, Ann. Rev. Fluid Mech., 23, 65-79, 1991
[11] Fish, F E, Imaginative Solution by Marine Organisms for Drag Reduction, West Chester University, West Chester, Pa. 19383
[12] A Guide to Organophosphorus Chemistry, by Quin, L D, Wiley Interscience, 2000.
[13] Modern Phosphonate Chemistry, by Sneignac P and Iorga B, CNC Press, 2003,
[14] Claudia Dworak, et. al., J. Polymer Science, Part A. Polymer Chemistry, 48, 13, 2914, 2010
[15] Joachim E. Klee and Uwe Lehmann, Beilstein, J. Org. Chem., 5, 766, 2010
[16] Fluorinated Ionomers, by Grot, G., William Andrew Inc., 2008

### BACKGROUND OF THE INVENTION

1. Field of Invention

This invention relates to a synthesis of a linear fluorocopolymer having a plurality of pendant phosphorus-containing functional groups. The synthesized phosphorus-containing fluorocopolymer has chain linearity and narrow molecular weight distributions. It has applications as a lubricant additive that provides friction-reduction, anti-wear, and corrosion protection properties.

2. Cross-Reference to Related Applications

Small molecular organophosphorus compounds serving as lubricant additives are well known [1, 2]. Fluorinated alternated, or diblock, or triblock, or multiblock copolymers are also well known [3-5]. Fluorinated ionomers with phosphonic functional groups are known [16].

However, a linear fluorinated alternated, or triblock, or multiblock copolymer with a plurality of pendant phosphorus-containing groups is unknown. A linear fluorinated alternated, or triblock, or multiblock copolymer with a plurality of pendant phosphorus-containing groups as a lubricant additive is also unknown.

3. Description of the Related Art

Many kinds of anti-wear, friction reduction lubricant additives are known. Organic phosphorus compounds such as dialkyl dithiophosphoric acids and dialkyl dithiophosphates and their metal salts are well known, such as zinc dialkyl dithiophosphates (ZDDPs), molybdenum dialkyl dithiophosphates [1, 2]. Since zinc, sulfides, and phosphorous poison catalysts in converters, the EPA has set 400 ppm allowance limits for ZDDP in lubricant motor oils.

Metal-free lubricant additives, such as nonylated triphenyl phosphorothionate, butylated triphenyl phosphorothionate, dithiophosphate, phosphoric acid ester, amine phosphate, and amine dithiophosphate have also been used as lubricant oil additives [1, 2]. However, small molecular organosulfide or organophosphorus lubricant additives have high vapor pressure and can thereby poison converter catalysts. Triphenyl derivatives, such as tricresyl phosphates (TCP), are environmental pollutants and neurotoxins.

Fluorinated compounds provide low friction, chemical stability and high temperature resistance, all qualities that are desired for a lubricant modifier [1, 2, 4]. U.S. Pat. No. 4,185,031 proposed a grease thickener prepared by reacting fluorinated olefins with a P—H bond acids. However, it is not suitable as an additive for lubricant oils due to its insolubility. U.S. Pat. No. 6,541,430, U.S. Pat. No. 6,764,984, U.S. Pat. No. 6,828,284, EP 1,265,906 proposed lubricant additives with fluorinated dialkyl dithiophosphoric acid and metallic salts. However, perfluorinated dialkyl dithiophosphoric acid and their metal salts are small molecular perfluorinated chemicals, and as such, are bioaccumulative and dangerous environmental pollutants; examples include perfluorooctane sulfonate (PFOA) and perfluorooctanoic acid (PFOS). U.S. Pat. No. 5,344,580 disclosed fluorine-containing oligomers as lubricating agents. However, perfluorinated oligomers are insoluble in lubricants.

Perfluorocarbon polymers, such as polytetrafluoroethylene (PTFE) and perfluoropolyether (PFPE) have the lowest friction coefficients [4].
There are many patents applying micronized PTFE as an ingredient in lubricant additives, such as U.S. Pat. Nos. 4,465,607, 4,806,281, 4,888,122, and many others. However, application of PTFE is limited to grease lubricants, and is not suitable for lubricant oils because PTFE is not soluble in lubricant oils [1, 2, 4]. The temporarily dispersed PTFE is unstable and will revert to its aggregate state, thereby blocking lubricant oil filters and causing filter failure.
Since fluorocarbon polymers cannot chemically bond to metal surfaces, U.S. Pat. No. 7,754,662 disclosed that an electron-beam irradiated PTFE (FI-PTFE) forms carboxyl groups which reacts with organophosphate, metal halide, etc. by mixing and heating. However, IF-PTFE products are insoluble in lubricants. Formulated lubricants comprise of surfactants, detergents, and dispersants that will destabilize the FI-PTFE dispersion and make the claimed mixture ineffective as a lubricant oil additive.

U.S. Pat. No. 6,828,284 disclosed a lubricant comprised of a phosphorus-containing perfluoropolyether (PFPE) and perfluoroalkyl phosphorus compounds. U.S. Pat. No. 5,874,169 disclose the perfluoro polyether phosphate as lubricant top. PFPE and related compounds are excellent lubricants, but not suitable for use as lubricant motor oil additives due to their insolubility in hydrocarbon lubricants. PFPE and related compounds are prohibitively expensive; thus, applications are limited to aerospace, watches, magnetic recording media, memory media, etc. [4].

U.S. Pat. Nos. 5,969,067 and 6,177,196 disclosed perfluorinated phosphorus-containing vinyl ether and its polymer. However, such vinyl ether is very expensive and insoluble in lubricant oils.

Perfluorinated phosphonated electrolyte with poly(4-phenoxybenzol-1,4-phenylene) groups disclosed by U.S. Pat. No. 7,3834,996, perfluorinated azole compounds with phosphonic groups disclosed by U.S. Pat. No. 7,727,651, polymer of (methyl)acrylamide with phosphorus groups disclosed by U.S. Pat. No. 7,452,487, polybenzazole containing phosphonic acid groups disclosed by U.S. Pat. No. 7,288,603, and electrolyte with perfluorinated vinyl ether phosphonic acid groups disclosed by U.S. Pat. No. 6,680,346 are perfluorinated ionomers [16]. They are useful as membrane material for electrolysis, fuel cells, batteries, ion exchange and sensors. However, It is not suitable as a lubricant oil additive due to its insolubility.

U.S. Pat. No. 5,032,306 disclosed a saturated hydrocarbon grafted with perfluoroolefin, and U.S. Pat. No. 6,642,186 disclosed a saturated hydrocarbon and saturated organic functional compounds grafted with fluorinated olefin. The products of saturated compounds are randomly grafted small molecules that do not belong to the oligomer or polymer.

In light of the current deficiencies, it is the object of the present invention to provide a fluorinated lubricant additive that can serve to reduce friction, provide anti-wear and anti-corrosion protection, and is compatible with conventional lubricant base fluids such as motor oils. Additionally, such a lubricant additive should also overcome the cost limitations and environmental concerns of previously known fluorinated compounds.

### BRIEF SUMMARY OF THE INVENTION

These and other objectives and advantages are achieved with the present invention, which relates to using a linear phosphorus-containing functional fluorocopolymer as a biomimetic approach to fish mucus polymers for friction reduction as a lubricant additive and the synthesis methods for said invented copolymer.

According to the first embodiment of the invention (direct synthesis), a linear phosphorus-containing fluorocopolymer is synthesized by copolymerization of monomers comprising of: (a) an oleophobic monomer being a fluoroolefin, (b) an oleophilic monomer being an aliphatic or cycloaliphatic oxygen-containing functional monomer, and (c) a metal bonding site monomer being an unsaturated phosphorus derivative of a vinyl group-containing monomer.

According to the second embodiment of the invention (sequential synthesis), a linear phosphorus-containing fluorinated copolymer is synthesized by sequential steps: (1) synthesis of a linear hydroxy fluorinated copolymer by copolymerization of monomers comprising of: (1a) an oleophobic monomer being a fluoroolefin, (1b) an oleophilic monomer being an aliphatic or cycloaliphatic oxygen-containing functional monomer, and (1c) a hydroxy-containing functional monomer, and

(2) conversion of linear hydroxy functional fluorinated copolymer to linear phosphorus-containing fluorinated copolymer by reacting with a phosphorus-containing reactant;

(3) may be followed with a reaction with a basic reactant selected from the group consisting of ammonia, aliphatic amine, cyclo aliphatic amine, n-methylpyrrolidone to synthesize a linear fluorinated copolymer with a phosphorus-containing salt or amide.

### DETAILED DESCRIPTION OF THE INVENTION

Research has shown that metal surfaces coated with PTFE have very low friction when in contact with an oil phase. However, coating metal with a thin film of PTFE is very difficult due to the high viscosity of PTFE even under high temperatures (above 360° C.). Secondly, since the PTFE coating will wear off, a method for continuous renewal of the PTFE coating must be provided.

Research also observed that fluorinated compounds undergo tribochemical reactions, which are friction-activated chemical reactions with metal surfaces that form a metal fluoride layer. Metal fluorides, such as iron fluoride, behave as solid lubricants. Formation of metal fluoride reduces wear in lubricant boundary regions, where starvation of lubricant or under extreme pressure conditions occur [1, 2].

However, all perfluoropolymers including PTFE are insoluble in lubricant oils. Mixing micronized or surface modified PTFE powders into lubricant oils does not produce continuously renewing PTFE coatings or metal fluoride layers.

It is known that the piston ring-cylinder liner system is the largest contributor to friction and energy waste in modern internal combustion engines. For a majority of the engine cycle, top piston rings come into contact with liner surfaces under dry or inadequate oil supply conditions. Oil control piston rings are pushed under high tension against liner surfaces coated with very thin layer of oil film. The piston ring pack spends a majority of its life in boundary or mixed lubrication regions. Boundary and mixed regions have more than ten times the friction of hydrodynamic regions.

The purpose of this invention is to provide a lubricant additive that squeezes the boundary region into a very narrow section under extremely high pressure and eliminates the mixed region by merging it into the hydrodynamic region. These improvements greatly reduce friction, fuel waste and wear on metal parts.

Research discovered that fish mucus reduces drag up to 65% [9]. Marine organism research discovered: (i) a layer of water immediately adjacent to the skin—the boundary layer—causes the majority of friction, (ii) the thickness of the boundary layer is proportional to the amount of friction [9-11]. Fish mucus reduces the thickness of the boundary layer by “smoothing” or “slickening” it. It was also found that the polymers in fish mucus have common characteristics: (i) water soluble, (ii) linear, with (iii) high molecular weight [9-11].

This invention further reduces friction in hydrodynamic lubrication region by using a biomimetic approach to replicate fish mucus polymers and to solve lubricant additive problems. This invention discovered a biomimetic reduction of the thickness of the boundary layer in lubricants by using linear phosphorus-containing fluorinated copolymers.

Accordingly, an object of this invention is to provide a partially fluorinated copolymer having linear phosphorus-containing functional groups with the capability to:
(1) Form a linear polymer with suitable solubility in lubricant oils;
(2) Form surface film on metal parts wherever lubricant oil comes into contact with metal surfaces;
(3) Form surface film that is constantly renewed and regenerated;
(4) Form surface film that is chemically bonded to metal surfaces;
(5) Form surface film that will retain lubricant oil on metal surfaces even in regions of poor lubricant supply or under extreme pressure, removing the possibility of dried oil on surfaces in the lubrication boundary region, and thus, greatly reducing friction and wear.
(6) Form surface film that replaces the metal/oil/metal lubrication pattern with fluorocopolymer/oil/fluoropolymer, thereby greatly reducing friction and wear.
(7) Form surface film that has liquid crystal phases in lubricant oil, thereby imitating the liquid crystal phase formed by high molecular weight fish mucus polymers in water.
(8) Form surface film on metal parts to reduce the thickness of the boundary layer and the momentum transfer through the boundary layer during the turbulent hydrodynamic flow of lubricant, thus reducing friction in hydrodynamic lubrication region.
(9) Protect metal parts from chemical corrosion and high temperature oxidation.
(10) Protect catalysts in exhaust converters.
(11) Provide ideal lubricant viscosity adjustments: increasing lubricant viscosity during slow flow or static conditions, and reducing lubricant viscosity during fast flow conditions.

These objectives have been achieved by the structural design of the phosphorus-containing functional fluorinated copolymers of the present invention.

The advantages of this invention are related to the linear fluorinated copolymer having a plurality of phosphorus-containing functional groups and include:
(1) The formation of a polymer with a linear main chain structure by using the invented polymerization conditions.
(2) The formation of a polymer with narrow molecular weight distributions and low viscosity by using the invented polymerization conditions.
(3) An invented chemical structure with oleophilic groups, which provides sufficient solubility in the lubricant oil phase and the capability to store lubricant oil in oleophilic groups.
(4) An invented chemical structure with pendant phosphorus-containing groups as metal bonding sites; these groups are highly reactive with metal and metal oxide on metal surfaces, resulting in strong chemical bonds.
(5) An invented chemical structure with suitable solubility in lubricant oils and at metal bonding sites to form surface film. The surface film is constantly renewed and regenerated wherever wearing of surface film occurs.
(6) A invented chemical structure that forms surface film that will retain lubricant oil even under extreme pressure or inadequate lubricant supply conditions, therefore eliminating lubrication boundary regions and reducing friction and wear.
(7) An invented chemical structure with oleophobic fluorocarbon bonds that form phase separation and liquid crystals in lubricants.
(8) An invented chemical structure with multiple fluorine-carbon bonds that provides chemical, oxidation, and high temperature resistance.
(9) An invented copolymer with a plurality of oleophobic fluoro-carbon bonds that form a separate liquid crystal boundary layer to smooth and slicken surface films, thereby reducing the thickness of the boundary layer and the rate of momentum transfer through the boundary layer during the turbulent hydrodynamic flow of lubricant, and greatly reducing friction and drag in the hydrodynamic region.
(10) An invented chemical structure that forms liquid crystal networks with a hydrocarbon lubricant, resulting in an increase in lubricant viscosity when the system is in slow movement or under extreme pressure, reducing wear and friction.
(11) An invented chemical structure that forms fluorocopolymer surface film capable of providing corrosion protection for metal surfaces.
(12) An invented polymer chemical structure that provides very low vapor pressure, which alleviates environmental concerns, and will not poison the catalyst in the exhaust converter.

All these advantages are realized by the present invention, which provides a linear phosphorus-containing fluorocopolymer which is comprised of repeating units based on (a) oleophobic units being fluorinated olefin monomers, (b) oleophilic units being oxygen-containing functional aliphatic or cycloaliphatic monomers and (c) metal bonding site units being an unsaturated phosphorus derivative of a vinyl group-containing monomer.

This invention discloses two methods that facilitate the synthesis of target fluorinated phosphorus-containing functional polymers from commercially available chemicals.

This invention discloses the first synthesis method. The first synthesis method is direct copolymerization of monomers comprising of unsaturated oleophobic fluorinated monomers, unsaturated oleophilic non-fluorinated monomers, and unsaturated metal bonding site phosphorus-containing monomers, and a mixture thereof.

This invention discloses a second synthesis method. The second synthesis method consists of sequential steps: (1) synthesis of a hydroxy functional fluorinated copolymer by the copolymerization of monomers comprising of an oleophobic unsaturated fluorinated monomer, an oleophilic unsaturated oxygen-containing functional monomer, and a hydroxy functional unsaturated monomer, (2) chemical reactions to convert hydroxy functional fluorinated copolymer to bonding site phosphorus-containing functional fluorinated copolymer.

The process for preparing the copolymers of the present invention is carried out according to known techniques [3, 5-8] by the copolymerization of the corresponding monomers in an organic solvent medium, in the presence of a suitable initiator at a temperature between −20° C. to 190° C., preferably between 40° C. to 120° C. The reaction pressure is between 1 to 100 Bars, preferably between 1 to 40 Bars.

Copolymerization of unsaturated monomers is commonly initiated by a radical initiator of an organic peroxide, inorganic peroxide, or azo compound [5, 6].

Living radical polymerization uses metal-carbene complexes as an initiator [7, 8].

Organic redox systems, such as tert-butylhydroperoxide/metabisulphite, can be used to initiate radical polymerization [7].

Metathesis catalysts, anionic catalysts, Zeigler-Natta coordination catalysts, organo-metallic compounds, and metal complexes involve organo-metal centers [7, 8].

Phosphorus-containing monomers or phosphorus-containing functional groups deactivate metal-carbene and the metallic center of a catalyst. Therefore, metal carbene or organo-metallic initiated copolymerization produces low yields or is forbidden when a phosphorus-containing monomer is used, such as in direct phosphorus-containing monomer copolymerization. Therefore, a radical initiator of copolymerization can be used for both direct synthesis and sequential synthesis methods of the present invention [5, 6].

The half-life temperature of the selected radical initiator determines the polymerization temperature [6].

Azo compounds of dialkyldiazenes, such as 2,2′-azobis (methylbutyronitrile), 1,1′-azobis (cyclohexanecarbonitrile), 2,2′-azobis (2-methylpropionitrile), 4,4′-azobiz(4-cyanovaleric acid), 2,2′-azobis(2,4-dimethyl valeronitrile) are common radical initiators. However, safety guidelines must be followed. Azo compounds are flammable solids and self-reacting compounds. They are constantly undergoing decomposition and releasing nitrogen; thus, non-vented containers cannot be used for storage or transportation. Refrigeration and elimination of fire, heat, and static electricity sources are required. At temperatures above the self-accelerating decomposition temperature (SADT), a sudden decomposition will blow apart the container and scatter azo compounds and toxic byproduct dust into the air.

Among the various radical initiators, organic peroxides are preferred. Common organic peroxide compounds are selected from the group consisting of diacyl peroxide, peroxyester, ketone peroxide, peroxydicarbonate, dialkyl, peroxide, hydroperoxide, peroxyketal, and a mixture thereof.
(1) Bis-acylperoxides of formula (R—CO—O)₂, wherein R is a alkyl C₁-C₁₀, among them, dibenzyl peroxide and dilauroyl peroxide, didecanoyl peroxide, succinic acid peroxide, diisononanoyl peroxide, and MEK peroxide are particularly preferred. However, diacyl peroxides are shock and friction sensitive, with the exception of bis-benzylperoxide that has been wetted and pasted.
(2) Dialkylperoxides of formula (R—O)₂, wherein R is an alkyl C₁-C₁₀; di-tert-butyl peroxide (DTBP), 2,5-dimethyl-2,5-bis(t-butylperoxy)hexane, dicumyl peroxide, and tert-amyl peroxide are particularly preferred; however, di-t-butyl peroxide has a low flash point and is highly flammable.
(3) Dialkylperoxydicarbonates, wherein the alkyl has from 1 to 8 carbon atoms, such as di-n-propyl-peroxydicarbonate and di-isopropyl-peroxydicarbonate. However, all peroxydicarbonates are thermally unstable and must remain refrigerated under recommended temperatures.
(4) Peroxyester is classified as t-alkyl esters of peroxycarboxylic acids, t-alkyl esters of monoperoxycarboxylic acids, di-t-alkyl esters of diperoxydicarboxylic acids, alkylene diesters of peroxycarboxylic acids, and t-alkyl diesters of monoperoxycarbonic acids. Peroxyesters offer the widest range of activity and is used extensively as free radical initiators for polymerization.
(5) Peroxyketals are extremely sensitive to acid contamination, which can cause rapid decomposition leading to the release of flammable vapors that may self-ignite.
(6) Since ketone peroxides suffer decomposition through chemical actions and are particularly sensitive to metallic salts, they are not recommended.
(7) Tert-amyl peroxides: t-amyl peroxy-neodecanoate, t-amyl peroxy-neoheptaneoate, t-amyl peroxy-pivalate, t-amyl peroxy-2-ethylhaxanoate, t-amyl peroxy benzoate, t-amyl peroxy acetate, 1,1-di(t-amylperoxy)cyclohexane, 2,2-di(t-amylperoxy)propane, ethyl 3,3-di(t-amylperoxy)butyrate, di-t-amyl peroxide, and O,O-t-amyl O-(2-ethylhexyl) monoperoxy carbonate are preferred t-amyl peroxides.

Radical initiators of tert-amyl peroxides provide the fluorocopolymer with chain linearity and narrow molecular weight distributions; therefore, it is the best initiator choice for the present invention.

The oleophobic monomer being a fluoroolefin is selected from the group consisting of tetrafluoroethylene, hexafluoropropylene, hexafluoroisobutylene, chlorotrifluoroethylene, vinylidene fluoride, difluoroethylene, trifluoroethylene, 3,3,3-trifluoropropene, 2,3,3,3-tetrafluoropropene, 1,2,3,3,3-pentafluoropropene, fluoroalkyl vinyl ether, hexafluoropropylene oxide, hydropentafluoropropylene, perfluoromethyl vinyl ether, perfluoropropyl vinyl ether, perfluoroalkyl acrylate, and a mixture thereof; Perfluoroolefin has the highest oleophobic and chemical stability. However, perfluoroalkyl vinyl ether, perfluoromethyl vinyl ether, perfluoropropyl vinyl ether and perfluoroalkyl acrylate are costly monomers; therefore, tetrafluoroethylene and hexafluoropropylene are the preferred monomers. Perfluorinated olefin provides the fluorocopolymer with properties such as low friction and chemical and high temperature stability.

The pressure required during copolymerization is determined by the partial pressure of the fluorinated monomer and its solubility in the solvent-monomer mixture under the reaction temperature. Under such partial pressure, the fluorinated monomer sustains its concentration in the copolymerization system.

The preferred chemical structure of the present invention is a copolymer with an alternating sequence of fluorinated monomer and non-fluorinated monomer. The fluorinated copolymer with an alternated fluorinated and non-fluorinated sequence has superior structure stability with better chemical, oxidation and high temperature resistance than a copolymer with random sequence structures. The copolymer with a block sequence has the least chemical stability against oxidation and high temperatures. A copolymer with an alternated sequence of fluoro-monomer and non-fluorinated monomer provides balanced oleophobic and oleophilic properties, and thus, is the best choice for the present invention.

A fluorine atom or fluorinated electron-withdrawing substituents directly linked to the ethylene makes the fluorinated olefin a good electron acceptor; examples include tetrafluoroethylene (TFE), hexafluoropropylene (HFP), 3,3,3-trifluoropropene (TEP), 2,3,3,3-tetrafluoropropene, 1,2,3,3,3-pentafluoropropene, chlorotrifluoroethylene (CTFE), perfluoroalkyl vinyl ether (PAVE), vinylidene fluoride (VDF), and hexafluoroisobutylene (HFIB). TFE and HFP with an end group CF₂═CF— bond are especially good electron acceptors.

Perfluorinated monomers are difficult to copolymerization with electron deficient monomers. Phosphorus-containing unsaturated monomers are also difficult to copolymerization with electron-deficient monomers.

Non-fluorinated monomers with an oxygen-containing functional group adjacent to the vinyl double bond, such as vinyl ether, vinyl ester, carbonate, and acrylate, provide an electron donor to the adjacent CH₂═CH— ethylene group.

The copolymerization of electron deficient fluoroolefin or phosphorus-containing unsaturated monomers with electron-rich, oxygen-containing functional non-fluorinated monomers is fast and easy.

For example, copolymerization using fluoroolefin as an acceptor and vinyl ether as a donor forms copolymers with a complete alternated sequence; alternated sequence structure copolymers are formed by the monomer combination.

Therefore, vinyl ether, vinyl ester, carbonate, acrylate, and anhydride are the preferred non-fluorinated unsaturated aliphatic or cycloaliphatic monomers.

The preferred unsaturated monomer is selected from monounsaturated aliphatic or cycloaliphatic monomers. The preferred monomer is selected from the group consisting of vinyl ether, vinyl ester, vinyl carbonate, vinyl anhydride, acrylate, and a mixture thereof.

Unsaturated aliphatic or cycloaliphatic units are hydrophilic. They provide the copolymer with solubility in lubricant oils, mineral lubricant oils, synthetic esters and polyglycols.

Functional monocyclic and polycyclic olefins having vinylene group in a ring and having oxygen-containing group adjacent to the vinylene group are preferred cyclic monomers. Copolymerization with cyclic monomers without ring-opening radical polymerization form linear copolymers with excellent chain flexibility and very low glass transition temperatures. Cyclic vinylene ether, cyclic vinylene ester, cyclic vinylene carbonate, and cyclic vinylene anhydride are preferred cyclic monomers that can be used in the synthesis of hydroxy functional fluoropolymers or in direct synthesis of linear phosphorus-containing fluoro-polymers.

The preferred aliphatic or cycloaliphatic vinyl ether monomer is selected from the group consisting of ethyl vinyl ether, iso-butyl vinyl ether, n-butyl vinyl ether, tert-butyl vinyl ether, cyclohexyl vinyl ether, dodecyl vinyl ether, iso-propyl vinyl ether, tert-amyl vinyl ether, triethylene glycol methyl vinyl ether, 2-ethyl hexyl vinyl ether, ethylene glycol butyl vinyl ether, 2-propyl heptanol vinyl ether, adamantyl vinyl ether, norbonyl vinyl ether, and a mixture thereof. Vinyl ether with branched aliphatic ether groups is preferred since it provides the lowest viscosity even under low temperatures. Therefore, tert-butyl vinyl ether, tert-amyl vinyl ether, iso-butyl vinyl ether, cyclohexyl vinyl ether, 2-ethyl hexyl vinyl ether, adamantyl vinyl ether, norbonyl vinyl ether, dihydrofuran, 3,4-dihydro-2H-pyran, and oxanorburnene are preferred.

The preferred unsaturated aliphatic and cycloaliphatic vinyl ester is selected from the group consisting of vinyl acetate, vinyl cyclohexanecarboxylic acid ester, vinyl 1,3-dioxolan-2-one, vinyl neodecanoate, vinyl propionate, vinyl butanate, vinyl isobutyrate, vinyl 2-methyl propanoate, vinyl tert-butyrate, vinyl isovalerate, vinyl 3-methyl butyrate, vinyl versatate, vinyl isobutyrate, vinyl pivalate, vinyl caproate, vinyl 2-methyl pentanoate, vinyl trifluoroacetate, and a mixture thereof. Vinyl ester with branched aliphatic acid groups is preferred since it provides the lowest viscosity under low temperatures. Therefore, vinyl tert-butyrate, vinyl versatate, and vinyl isovalerate are preferred.

The preferred unsaturated aliphatic and cycloaliphatic acrylate is selected from the group consisting methyl acrylate, ethyl acrylate, propyl acrylate, butyl acrylate, iso-butyl acrylate, tert-butyl acrylate, amyl acrylate, tert-amyl acrylate, 2-ethylhexyl acrylate, lauryl acrylate, cyclohexyl acrylate, stearyl acrylate, methyl methacrylate, ethyl methacrylate, propyl methacrylate, butyl methacrylate, iso-butyl methacrylate, tert-butyl methacrylate, amyl methacrylate, tert-amyl methacrylate, 2-ethylhexyl methacrylate, lauryl methacrylate, cyclohexyl methacrylate, stearyl methacrylate, and a mixture thereof. Acrylates with branched aliphatic ester groups are preferred since they provide the lowest viscosity under low temperatures. Therefore, tert-butyl acrylate, tert-amyl acrylate, cyclohexyl acrylate, tert-butyl methacrylate, tert-amyl methacrylate, cyclohexyl methacrylate are preferred acrylate units.

A preferred acrylate with fluorinated alkyl, vinyl ether with fluorinated alkyl, and vinyl ester with fluorinated alkyl, provide low surface energy pendant fluorinated groups. The phase separation effect by the fluorinated polymer chains is enhanced. However, they are costly monomers.

There are limited vinyl carbonates available: 1,3vinyl-dioxolan-2-one, and vinylene carbonate.

Choices for commercially available vinyl anhydride are limited: maleic anhydride, itaconic anhydride, and citraconic anhydride.

The preferred oleophilic monomer being an aliphatic or cycloaliphatic oxygen-containing functional monomer is selected from the group consisting of:

(a) vinyl ether selected from the group consisting of ethyl vinyl ether, iso-butyl vinyl ether, n-butyl vinyl ether, tert-butyl vinyl ether, cyclohexyl vinyl ether, dodecyl vinyl ether, octadecyl vinyl ether, iso-propyl vinyl ether, tert-amyl vinyl ether, triethylene glycol methyl vinyl ether, 2-ethyl hexyl vinyl ether, ethylene glycol butyl vinyl ether, 2-propyl heptanol vinyl ether, adamantyl vinyl ether, norbonyl vinyl ether, dihydrofurane, dihydropyran, and a mixture thereof;
(b) vinyl ester selected from the group consisting of vinyl acetate, vinyl cyclohexanecarboxylic acid ester, vinyl neodecanoate, propionate, vinyl butanate, vinyl isobutyrate, vinyl 2-methyl propanoate, vinyl tert-butyrate, vinyl isovalerate, vinyl 3-methyl butyrate, vinyl versatate, vinyl isobutyrate, vinyl pivalate, vinyl caproate, vinyl 2-methyl pentanoate, vinyl trifluoroacetate, and a mixture thereof;
(c) acrylate selected from the group consisting of methyl acrylate, ethyl acrylate, propyl acrylate, butyl acrylate, iso-butyl acrylate, tert-butyl acrylate, amyl acrylate, tert-amyl acrylate, 2-ethylhexyl acrylate, lauryl acrylate, cyclohexyl acrylate, stearyl acrylate, methyl methacrylate, ethyl methacrylate, propyl methacrylate, butyl methacrylate, iso-butyl methacrylate, tert-butyl methacrylate, amyl methacrylate, tert-amyl methacrylate, 2-ethylhexyl methacrylate, lauryl methacrylate, cyclohexyl methacrylate, stearyl methacrylate, and a mixture thereof;
(d) vinyl carbonate selected from the group consisting of 1,3vinyl-dioxolan-2-one, vinylene carbonate, and a mixture thereof;
(e) vinyl anhydride selected from the group consisting of maleic anhydride, itaconic anhydride, citraconic anhydride, and a mixture thereof; and,
(f) functional cyclic monomer selected from the group consisting of dihydrofuran, 3,4-dihydro-2H-pyran, oxanorburnene, and a mixture thereof.

The metal bonding site monomer being an unsaturated phosphorus derivative of vinyl or vinylene monomer is selected from the group consisting of vinyl ether derivative of phosphoric acid, vinyl ester derivative of phosphoric acid, vinyl formate derivative of phosphoric acid, acrylate derivative of phosphoric acid, vinyl ether derivative of phosphonic acid, vinyl ester derivative of phosphonic acid, vinyl formate derivative of phosphonic acid, acrylate derivative of phosphonic acid, vinyl ether derivative of thiophosphoric acid, vinyl ester derivative of thiophosphoric acid, vinyl formate derivative of thiophosphoric acid, acrylate derivative of thiophosphoric acid, vinyl ether derivative of thiophosphonic acid, vinyl ester derivative of thiophosphonic acid, vinyl formate derivative of thiophosphonic acid, acrylate derivative of thiophosphonic acid, vinyl ether derivative of dithiophosphoric acid, vinyl ester derivative of dithiophosphoric acid, vinyl formate derivative of dithiophosphoric acid, acrylate derivative of dithiophosphoric acid, vinyl ether derivative of dithiophosphonic acid, vinyl ester derivative of dithiophosphonic acid, vinyl formate derivative of dithiophosphonic acid, acrylate derivative of dithiophosphonic acid, and a mixture thereof.

Unsaturated phosphorus derivatives of vinyl or vinylene monomers are commonly used for non-priming dental adhesives. Several books of synthesis methods are available [12, 13].

The preferred bonding site unsaturated phosphorus derivative of a vinyl or vinylene group-containing monomer is selected from the group consisting of vinylphosphonic acid dimethyl ester, vinylphosphonic acid diethyl ester, vinyloxycarbonyl phosphonic acid dimethyl ester, vinyloxycarbonyl phosphonic acid diethyl ester, vinyloxybutylcarbonyl phosphoric dimethyl ester, vinyloxybutylcarbonyl phosphoric diethyl ester, vinyloxybutyl phosphoric dimethyl ester, vinyloxybutyl phosphoric diethyl ester, acryloyl dimethyl phosphate, acryloyl diethyl phosphate, 2-(acryloyloxy)ethyl phosphonic dimethyl ester, 2-(acryloyloxy)ethyl phosphonic diethyl ester, dimethoxyphosphonoxy butyl prop-2-enoate, diethyoxyphosphooxy butyl prop-2-enoate, 1-vinyl-2-ethyoxy phosphoric dimethyl ester, 1-vinyl-2-ethyoxyl phosphoric diethyl ester, 1-vinyl-2-(ethyoxy)ethyl phosphoric dimethyl ester, 1-vinyl-2-(ethyoxy)ethyl phosphoric diethyl ester, 1-vinyl-2-(ethyoxy ethyoxy)ethyl phosphoric dimethyl ester, 1-vinyl-2-(ethyoxy ethyoxy)ethyl phosphoric diethyl ester, 1-[(dimethoxyphosphoryl)oxy]ethyl prop-2-enoate, 1-[(dimethoxyphosphoryl)oxy]propyl prop-2-enoate, 1-[(dimethoxyphosphoryl)oxy]butyl prop-2-enoate, 1-[(diethoxyphosphoryl)oxy]ethyl prop-2-enoate, 1-[(diethoxyphosphoryl)oxy]propyl prop-2-enoate, 1-[(diethoxyphosphoryl)oxy]butyl prop-2-enoate, 2-(omega-phosphonooxy-2-oxapropyl)acrylate, 2-(omega-phosphonooxy-2-oxaethyl)acrylate, and a mixture thereof.

The preferred unsaturated phosphorus-containing monomers are vinylphosphonic acid dimethyl ester, vinylphosphonic acid diethyl ester, vinylphosphonic acid methyl ethyl ester, dimethyl phosphoric acid vinyl ester, diethyl phosphoric acid vinyl ester, methyl ethyl phosphoric acid vinyl ester, diethoxy phosphonovinyl formate [14], dimethoxy phosphonovinyl formate [14], dimethoxyphosphoryl acrylate, diethoxyphosphoryl acrylate, {3-[2-methylacryloyl]propyl}phosphonic acid dimethyl ester, (dimethoxyphosphonoxy)ethyl acrylate, diethyl ({[(prop-2-en-1-yloxy)carbonyl]oxy}methyl)phosphonate, 1-(dimethoxyphosphonoxy)propyl prop-2-enoate, (dimethoxyphosphonoxy)ethyl acrylate, dimethoxyphosphoryloxy propyl acrylate, vinyloxycarbonyl phosphonic acid dimethyl ester, vinyloxycarbonyl phosphonic acid diethyl ester, 2-(omega-phosphonooxy-2-oxapropyl)acrylate [15], 2-(omega-phosphonooxy-2-oxaethyl)acrylate [15], and a mixture thereof.

The preferred hydroxy-containing functional monomer is selected from the group consisting of hydroxyalkyl vinyl ether, hydroxyalkyloxy vinyl ether, hydroxycyclohexyl vinyl ether, hydroxyalkyl acrylate, hydroxyalkyloxy acrylate, hydroxycyclohexyl acrylate, hydroxyalkyl carboxylic vinyl ester, hydroxyalkyloxy carboxylic vinyl ester, and a mixture thereof.

The preferred hydroxy functional unsaturated monomer is selected from the group consisting of hydroxybutyl vinyl ether, diethylene glycol monovinyl ether, 4-(hydroxymethyl)cyclohexyl methyl vinyl ether, hydroxyethyl acrylate, hydroxypropyl acrylate, hydroxybutyl acrylate, 2-ethyl hydroxyethyl acrylate, hydroxymethyl-cyclohexyl acrylate, hydroxyethyl methacrylate, hydroxypropyl methacrylate, hydroxybutyl methacrylate, 2-ethyl hydroxyethyl methacrylate, butanediol monoacrylate, hydroxybutyric acid vinyl ester, hydroxydecanoic acid vinyl ester, hydroxydodecanoic acid vinyl ester, hydroxyhaxadecanoic acid vinyl ester, hydroxyhexanoic acid vinyl ester, and a mixture thereof.

The target compound of this invention is a phosphorus-containing functional fluoropolymer. The conversion of hydroxy functional groups into phosphorus-containing groups is required. Geometric unblocked phosphate groups are easily accessible by metal atoms. Therefore, hydroxybutyl vinyl ether, diethylene glycol monovinyl ether, hydroxypropyl acrylate, hydroxybutyl acrylate, hydroxybutyl methacrylate, butanediol monoacrylate, hydroxybutyric acid vinyl ester, hydroxyhexanoic acid vinyl ester, and a mixture thereof, are the preferred unsaturated hydroxy functional units.

To convert the hydroxy group into a phosphorus-containing group, such as a phosphoryl or thiophosphoryl group, usage of the following compounds are preferred: tetraphosphorus decaoxide (P₄O₁₀), tetraphosphorus hexaoxide tetrasulfide (P₄O₆S₄), tetraphosphorus decasulfide (P₄S₁₀), dialkyl phosphinic chloride, dialkyl phosphonic chloride, dialkyl phosphoric chloride, trialkyl phosphoric ester, O,O-dialkyl thiophosphoryl chloride, dialkyl thiophosphonic chloride, dialkyl phosphodithioic chloride, and a mixture thereof [12, 13].

To neutralize the phosphoric acid or phosphonic acid group, usage of the following compounds are preferred: ammonia, aliphatic amine cycloaliphatic amine, such as, ammonia, diethylamine, dimethylamine, ethylmethylamine, trimethylamine, triethylamine, N-methylpyrrolidone, N,N-dimethylformamide, cyclohexylamine, and a mixture thereof.

Copolymerization can be conducted in a solvent or water medium, dispersed as an emulsion or a suspension. Since the application of the present invention is for a lubricant additive, a water-free solvent medium is preferred.

In the solution polymerization, the reacting monomers and formed polymers are dissolved in an organic solvent, which reduces viscosity and increases heat transfer during the reaction. In the two-step synthesis, the same solvents are used in the copolymerization medium during the first step, and in the reaction medium during the second step of phosphorus functionalization.

The following solvents are not preferred: chlorofluorocarbons, which deplete ozone in the stratosphere, hydrofluorocarbons, which are very expensive, and aromatic solvents and most hydrochlorocarbons, which are hazardous pollutants. Alcohols or hydroxy functional hydrocarbons cannot be used as a solvent for polymerization or as reaction medium during convert hydroxy function groups into phosphorus-containing functional groups.

Hydrocarbons with a branched chain of 6 to 25 carbon atoms and a ratio between methyl groups and carbon atoms that is higher than 0.5, such as 2,3-dimethylbutane, 2,3-dimethylpentane, 2,2,4-trimethylpentane, 2,2,4,6,6-pentamethylheptane, and 2,2,4,4,6-pentamethylheptane, are preferred due to their low viscosity even under low temperatures. Ketones, esters, and ethers with branched chains are also preferred. Organic compounds that are not considered as VOCs by the EPA, such tert-butyl acetate, are especially preferred.

Chain transfer agents provide molecular weight control, reduced gel, and colorless final product. Thiols, disulfides, monosulfides, C₃-C₅ saturated hydrocarbon in 1-0.05% amount of total monomer, are preferred chain transfer agent.

According to the first embodiment of the invention (direct synthesis), a phosphorus-containing fluorinated copolymer is synthesized by copolymerization of monomers comprising of: (1) hydrophobic units being fluoroolefins; (2) hydrophilic units being oxygen-containing functional olefins selected from the group consisting of vinyl ether, vinyl ester, acrylate, vinyl or vinylene carbonate, vinyl or vinylene anhydride, dihydrofuran, 3,4-dihydro-2H-pyran, oxanorburnene, and a mixture thereof; (3) metal bonding units being phosphorus-containing monomers with a vinyl or a vinylene functional group.

A linear phosphorus-containing fluorinated copolymer comprising:

(a) copolymerized units of an oleophobic monomer, said oleophobic monomer being a fluoroolefin,
(b) copolymerized units of an oleophilic monomer, said oleophilic monomer being an aliphatic or cycloaliphatic oxygen-containing functional monomer, and
(c) copolymerized units of a metal bonding site monomer, said metal bonding site monomer being an unsaturated phosphorus derivative of a vinyl or vinylene group-containing monomer.

A linear phosphorus-containing fluorinated copolymer wherein an oleophobic monomer being a fluoroolefin is selected from the group consisting of: tetrafluoroethylene, hexafluoropropylene, hexafluoroisobutylene, chlorotrifluoroethylene, vinylidene fluoride, difluoroethylene, trifluoroethylene, 3,3,3-trifluoropropene, 2,3,3,3-tetrafluoropropene, 1,2,3,3,3-pentafluoropropene, fluoroalkyl vinyl ether, hydropentafluoropropylene, perfluoromethyl vinyl ether, perfluoropropyl vinyl ether, and a mixture thereof;

A linear phosphorus-containing fluorinated copolymer wherein an oleophilic monomer being an aliphatic or cycloaliphatic oxygen-containing functional monomer is selected from the group consisting of:

(a) vinyl ether selected from the group consisting of ethyl vinyl ether, iso-butyl vinyl ether, n-butyl vinyl ether, tert-butyl vinyl ether, cyclohexyl vinyl ether, dodecyl vinyl ether, octadecyl vinyl ether, iso-propyl vinyl ether, tert-amyl vinyl ether, triethylene glycol methyl vinyl ether, 2-ethyl hexyl vinyl ether, ethylene glycol butyl vinyl ether, 2-propyl heptanol vinyl ether, adamantyl vinyl ether, norbonyl vinyl ether, dihydrofurane, dihydropyran, and a mixture thereof;
(b) vinyl ester selected from the group consisting of vinyl acetate, vinyl cyclohexanecarboxylic acid ester, vinyl neodecanoate, vinyl propionate, vinyl butanate, vinyl isobutyrate, vinyl 2-methyl propanoate, vinyl tert-butyrate, vinyl isovalerate, vinyl 3-methyl butyrate, vinyl versatate, vinyl isobutyrate, vinyl pivalate, vinyl caproate, vinyl 2-methyl pentanoate, vinyl trifluoroacetate, and a mixture thereof;
(c) acrylate selected from the group consisting of methyl acrylate, ethyl acrylate, propyl acrylate, butyl acrylate, iso-butyl acrylate, tert-butyl acrylate, amyl acrylate, tert-amyl acrylate, 2-ethylhexyl acrylate, lauryl acrylate, cyclohexyl acrylate, stearyl acrylate, methyl methacrylate, ethyl methacrylate, propyl methacrylate, butyl methacrylate, iso-butyl methacrylate, tert-butyl methacrylate, amyl methacrylate, tert-amyl methacrylate, 2-ethylhexyl methacrylate, lauryl methacrylate, cyclohexyl methacrylate, stearyl methacrylate, and a mixture thereof;
(d) vinyl carbonate selected from the group consisting of 13 vinyl-dioxolan-2-one, vinylene carbonate, and a mixture thereof;
(e) vinyl anhydride selected from the group consisting of maleic anhydride, itaconic anhydride, citraconic anhydride, and a mixture thereof; and,
(f) functional cyclic monomer selected from the group consisting of dihydrofuran, 3,4-dihydro-2H-pyran, oxanorburnene, and a mixture thereof.

A linear phosphorus-containing fluorinated copolymer wherein a metal bonding site monomer being an unsaturated phosphorus derivative of a vinyl or vinylene group-containing monomer is selected from the group consisting of vinyl ether derivative of phosphoric acid, vinyl ester derivative of phosphoric acid, vinyl formate derivative of phosphoric acid, acrylate derivative of phosphoric acid, vinyl ether derivative of phosphonic acid, vinyl ester derivative of phosphonic acid, vinyl formate derivative of phosphonic acid, acrylate derivative of phosphonic acid, vinyl ether derivative of thiophosphoric acid, vinyl ester derivative of thiophosphoric acid, vinyl formate derivative of thiophosphoric acid, acrylate derivative of thiophosphoric acid, vinyl ether derivative of thiophosphonic acid, vinyl ester derivative of thiophosphonic acid, vinyl formate derivative of thiophosphonic acid, acrylate derivative of thiophosphonic acid, vinyl ether derivative of dithiophosphoric acid, vinyl ester derivative of dithiophosphoric acid, vinyl formate derivative of dithiophosphoric acid, acrylate derivative of dithiophosphoric acid, vinyl ether derivative of dithiophosphonic acid, vinyl ester derivative of dithiophosphonic acid, vinyl formate derivative of dithiophosphonic acid, acrylate derivative of dithiophosphonic acid, and a mixture thereof.

A linear phosphorus-containing fluorinated copolymer wherein an unsaturated phosphorus derivative of a vinyl or vinylene group-containing monomer is selected from the group consisting of vinylphosphonic acid dimethyl ester, vinylphosphonic acid diethyl ester, vinyloxycarbonyl phosphonic acid dimethyl ester, vinyloxycarbonyl phosphonic acid diethyl ester, vinyloxybutylcarbonyl phosphoric dimethyl ester, vinyloxybutylcarbonyl phosphoric diethyl ester, vinyloxybutyl phosphoric dimethyl ester, vinyloxybutyl phosphoric diethyl ester, acryloyl dimethyl phosphate, acryloyl diethyl phosphate, 2-(acryloyloxy)ethyl phosphonic dimethyl ester, 2-(acryloyloxy)ethyl phosphonic diethyl ester, dimethoxyphosphonoxy butyl prop-2-enoate, diethyoxyphosphooxy butyl prop-2-enoate, 1-vinyl-2-ethyoxy phosphoric dimethyl ester, 1-vinyl-2-ethyoxyl phosphoric diethyl ester, 1-vinyl-2-(ethyoxy)ethyl phosphoric dimethyl ester, 1-vinyl-2-(ethyoxy)ethyl phosphoric diethyl ester, 1-vinyl-2-(ethyoxy ethyoxy)ethyl phosphoric dimethyl ester, 1-vinyl-2-(ethyoxy ethyoxy)ethyl phosphoric diethyl ester, 1-[(dimethoxyphosphoryl)oxy]ethyl prop-2-enoate, 1-[(dimethoxyphosphoryl)oxy]propyl prop-2-enoate, 1-[(dimethoxyphosphoryl)oxy]butyl prop-2-enoate, 1-[(diethoxyphosphoryl)oxy]ethyl prop-2-enoate, 1-[(diethoxyphosphoryl)oxy]propyl prop-2-enoate, 1-[(diethoxyphosphoryl)oxy]butyl prop-2-enoate, 2-(omega-phosphonooxy-2-oxapropyl)acrylate, 2-(omega-phosphonooxy-2-oxaethyl)acrylate, and a mixture thereof.

A linear phosphorus-containing fluorinated copolymer wherein the polymerization of said linear phosphorus-containing fluorinated copolymer is initialized with a radical initiator selected from tert-amyl peroxides.

Tert-butyl acetate is preferred as a polymerization solvent.

A basic reactant is selected from the group consisting of ammonia, aliphatic amine, cyclic aliphatic amine, n-methylpyrrolidone, and a mixture thereof, which serves as the neutralization reactant for formed reaction product of polymerization. The neutralization product is well suited as a lubricant additive.

According to a second embodiment of the invention (sequential synthesis): a phosphorus-containing fluorinated copolymer is synthesized by two sequential steps: (1) synthesis of linear hydroxy fluorinated copolymer by copolymerization of monomers comprising of (1a) oleophobic units being fluoroolefins, (1b) oleophilic units being saturated oxygen-containing aliphatic or cycloaliphatic monomers, (1c) hydroxy functional units being hydroxy functional monomers, followed by (2) conversion of hydroxy functional groups into phosphorus-containing groups by reacting with a phosphorus-containing reactant. (3) A subsequent step of neutralizing the free acid group into a salt or amide group using ammonia, aliphatic amine, cycloaliphatic amine, or N-methylpyrrolidone, may follow to synthesize a linear fluorinated copolymer with phosphorus-containing groups.

A linear phosphorus-containing fluorinated copolymer comprising of a reaction product between:

(a) a hydroxy functional fluorinated copolymer and
(b) a phosphorus-containing reactant;

A linear phosphorus-containing fluorinated copolymer wherein the hydroxyl functional fluorinated copolymer comprises of:

(a) copolymerized units of an oleophobic monomer, said oleophobic monomer being a fluoroolefin,
(b) copolymerized units of an oleophilic monomer, said oleophilic monomer being an aliphatic or cycloaliphatic oxygen-containing functional monomer, and
(c) copolymerized units of a hydroxy-containing functional monomer.

A linear hydroxy functional group fluorinated copolymer wherein an oleophobic monomer being a fluoroolefin is selected from the group consisting of tetrafluoroethylene, hexafluoropropylene, hexafluoroisobutylene, chlorotrifluoroethylene, vinylidene fluoride, difluoroethylene, trifluoroethylene, 3,3,3-trifluoropropene, 2,3,3,3-tetrafluoropropene, 1,2,3,3,3-pentafluoropropene, fluoroalkyl vinyl ether, hydropentafluoropropylene, perfluoromethyl vinyl ether, perfluoropropyl vinyl ether, and a mixture thereof;

A linear hydroxy functional group fluorinated copolymer wherein an oleophilic monomer being an aliphatic or cycloaliphatic oxygen-containing functional monomer is selected from the group consisting of:

(a) vinyl ether selected from the group consisting of ethyl vinyl ether, iso-butyl vinyl ether, n-butyl vinyl ether, tert-butyl vinyl ether, cyclohexyl vinyl ether, dodecyl vinyl ether, octadecyl vinyl ether, iso-propyl vinyl ether, tert-amyl vinyl ether, triethylene glycol methyl vinyl ether, 2-ethyl hexyl vinyl ether, ethylene glycol butyl vinyl ether, 2-propyl heptanol vinyl ether, adamantyl vinyl ether, norbonyl vinyl ether, dihydrofurane, dihydropyran, and a mixture thereof;
(b) vinyl ester selected from the group consisting of vinyl acetate, vinyl cyclohexanecarboxylic acid ester, vinyl neodecanoate, vinyl propionate, vinyl butanate, vinyl isobutyrate, vinyl 2-methyl propanoate, vinyl tert-butyrate, vinyl isovalerate, vinyl 3-methyl butyrate, vinyl versatate, vinyl isobutyrate, vinyl pivalate, vinyl caproate, vinyl 2-methyl pentanoate, vinyl trifluoroacetate, and a mixture thereof;
(c) acrylate selected from the group consisting of methyl acrylate, ethyl acrylate, propyl acrylate, butyl acrylate, iso-butyl acrylate, tert-butyl acrylate, amyl acrylate, tert-amyl acrylate, 2-ethylhexyl acrylate, lauryl acrylate, cyclohexyl acrylate, stearyl acrylate, methyl methacrylate, ethyl methacrylate, propyl methacrylate, butyl methacrylate, iso-butyl methacrylate, tert-butyl methacrylate, amyl methacrylate, tert-amyl methacrylate, 2-ethylhexyl methacrylate, lauryl methacrylate, cyclohexyl methacrylate, stearyl methacrylate, and a mixture thereof;
(d) vinyl carbonate selected from the group consisting of 1,3vinyl-dioxolan-2-one, vinylene carbonate, and a mixture thereof;
(e) vinyl anhydride selected from the group consisting of maleic anhydride, itaconic anhydride, citraconic anhydride, and a mixture thereof; and,
(f) functional cyclic monomer selected from the group consisting of dihydrofuran, 3,4-dihydro-2H-pyran, oxanorburnene, and a mixture thereof.

A linear hydroxy functional group fluorinated copolymer wherein a hydroxy-containing functional monomer is selected from the group consisting of hydroxybutyl vinyl ether, diethylene glycol monovinyl ether, 4-(hydroxymethyl)cyclohexyl methyl vinyl ether, hydroxyethyl acrylate, hydroxypropyl acrylate, hydroxybutyl acrylate, 2-ethyl hydroxyethyl acrylate, hydroxymethyl-cyclohexyl acrylate, hydroxyethyl methacrylate, hydroxypropyl methacrylate, hydroxybutyl methacrylate, 2-ethyl hydroxyethyl methacrylate, butanediol monoacrylate, hydroxybutyric acid vinyl ester, hydroxydecanoic acid vinyl ester, hydroxydodecanoic acid vinyl ester, hydroxyhaxadecanoic acid vinyl ester, hydroxyhexanoic acid vinyl ester, and a mixture thereof.

A linear hydroxy functional group fluorinated copolymer wherein polymerization of said hydroxy-containing functional polymer is initialized by a radical initiator selected from tert-amyl peroxides.

Conversion of a linear hydroxy functional group fluorinated copolymer into a linear phosphorus-containing fluorinated copolymer wherein a phosphorus-containing reactant is selected from the group consisting of tetraphosphorus decaoxide (P₄O₁₀), tetraphosphorus hexaoxide tetrasulfide (P₄O₆S₄), tetraphosphorus decasulfide (P₄S₁₀), dialkyl phosphinic chloride, dialkyl phosphonic chloride, dialkyl phosphoric chloride, trialkyl phosphoric ester, O,O-dialkyl thiophosphoryl chloride, dialkyl thiophosphonic chloride, dialkyl phosphodithioic chloride, and a mixture thereof.

Tert-butyl acetate is a preferred solvent for the polymerization of a linear hydroxy functional group fluorinated copolymer and for the conversion reaction of hydroxy groups into phosphorus-containing groups of a fluorocopolymer.

The reaction mixture formed by the conversion of hydroxy groups into phosphorus-containing groups can be neutralized with a basic reactant selected from the group consisting of ammonia, aliphatic amine, cycloaliphatic amine, n-methylpyrrolidone, and a mixture thereof.

The neutralized mixture can be used as an ingredient for a lubricant additive exhibiting friction reduction, viscosity modification, anti-wear, and corrosion protection characteristics.

### Example 1

### Direct Synthesis

A pre-dried autoclave having an internal capacity of 2.5 liters and equipped with a stirrer, gas inlet port, liquid injection port, liquid sampling port, and thermometer, was charged with 630 g of tert-butyl acetate, and 342 g (3.0 mol) of tert-amyl vinyl ether, 54.4 g (0.4 mol) of vinylphosphonic acid dimethyl ester, and 0.46 g (2E-3 mol) of t-amyl peroxy-2-ethylhaxanoate. After the mixture was held at a temperature of −20° C. and slowly stirred, the autoclave was then evacuated for 15 minutes and purged five times with nitrogen. Then, the autoclave was charged with tetrafluoroethylene under 2 Bars pressure. The mixture in the autoclave was heated to 96° C., and charged with TFE to raise the pressure to 4 Bars. The polymer initiator solution, 1 ml 0.017M of t-amyl peroxy-2-ethylhaxanoate in t-amyl acetate solution containing 3.03 g/L of t-amyl peroxy-2-ethylhanoate, was injected into the autoclave to initiate polymerization. Every 10 minutes thereafter, 1 ml of the 0.017M t-amyl peroxy-2-ethylhaxanoate in t-amyl acetate polymerization initiator solution was injected. Furthermore, TFE was continuously charged in order to maintain the pressure at 4 Bars during the polymerization, and the consumption of TFE was recorded. After 5 hours from the initiation of the polymerization, a total of 360 g (3.6 mol) of TFE was charged and both the initiator solution and the TFE supply were stopped. The mixture temperature was slowly risen to 105° C. and kept there for 1 hr. Afterward, the mixture in the autoclave was lowered to room temperature and then purged with nitrogen to remove unreacted monomers, and the system was brought to atmospheric pressure. The resulting phosphonic ester functional fluorocopolymer in t-butyl acetate solution was removed from the autoclave. 1,356 g of phosphorus-containing fluorocopolymer solution was recovered.

From the results of NMR and infrared absorption spectrum analysis, the phosphorus-containing functional fluorocopolymer has repeating units based on tetrafluoroethylene/repeating units based on t-amyl vinyl ether/repeating units based on vinylphosphonic acid dimethyl ester: 50/44/6 (mol %). The solids percentage was 52%. The VOC of the phosphorus-containing functional fluorocopolymer solution was 1.5 g/L.

### Example 2

### Direct Synthesis

Polymerization autoclave used in Example 1 was deaerated and charged with 830 g of tert-butyl acetate, 135 g (0.9 mol) of hexafluoropropylene (HFP), 366 g (2.9 mol) of cyclohexyl vinyl ether, 104 g (0.5 mol) of vinyloxycarbonylphosphonic acid dimethyl ester, 2.5 g of 1-butanethiol, and 0.416 g (2E-3 mol) of t-amyl peroxy-2-benzoate. After the mixture was held at a temperature of −20° C. and slowly stirred, the autoclave was then evacuated for 15 minutes and purged five times with nitrogen. The autoclave was charged with tetrafluoroethylene under 2 Bars pressure. Then, the mixture in the autoclave was heated to 121° C., and charged with TFE to raise the pressure to 4 Bars. The polymer initiator solution, 1 ml 0.017M of t-amyl peroxy benzoate in t-amyl acetate solution containing 3.47 g/L of t-amyl peroxy benzoate, was injected into the autoclave to initiate polymerization. Every 10 minutes thereafter, 1 ml of the 0.017M t-amyl peroxy benzoate in t-amyl acetate polymerization initiator solution was injected. Further, TFE was continuously charged in order to maintain the pressure at 4 Bars during the polymerization, and the consumption of TFE was recorded. After 5 hours from the initiation of the polymerization, a total of 267 g (2.67 mol) of TFE was charged, and both the initiator solution and the TFE supply were stopped. The mixture temperature was slowly risen to 135° C. and kept there for 1 hr. Then the mixture in the autoclave was lowered to room temperature. Afterward, the autoclave was purged with nitrogen to remove unreacted monomers and the system was brought to atmospheric pressure.

The resulting phosphonic ester functional fluorocopolymer in t-butyl acetate solution was removed from the autoclave. 1,682 g of phosphorus-containing fluorocopolymer solution was recovered.

From the results of NMR and infrared absorption spectrum analysis, the phosphorus-containing functional fluorocopolymer has repeating units based on tetrafluoroethylene/repeating units based on hexafluoropropylene/repeating units based on hexyl vinyl ether/repeating units based on vinyloxycarbonylphosphonic acid dimethyl ester: 36.8/13.2/42.4/7.6 (mol %). The solids percentage was 51%. The VOC of the phosphorus-containing functional fluorocopolymer solution was 1.5 g/L.

### Example 3

### Direct Synthesis

The polymerization autoclave used in Example 1 was pre-dried. The autoclave was charged with 700 g of tert-butyl acetate, 384 g (3.0 mol) of tert-butyl acrylate, 112 g (0.50 mol) of (dimethoxyphosphonoxy)ethyl acrylate, 3.5 g of di-n-butyl disulfide, and 0.46 g (2E-3 mol) of t-amyl peroxy-2-ethylhaxanoate. The autoclave was deaerated. The mixture was held at −25° C., and then 360 g (3.75 mol) of 3,3,3-trifluoropropene was charged under a pressure of 35.6 Bars while the mixture was slowly stirred. The mixture in the autoclave was then heated to 96° C. The polymer initiator solution, 1 ml 0.017M of t-amyl peroxy-2-ethylhaxanoate in t-butyl acetate solution containing 3.03 g/L of t-amyl peroxy-2-ethylhanoate, was injected into the autoclave to initiate polymerization. Every 10 minutes thereafter, 1 ml of the 0.017M t-amyl peroxy-2-ethylhaxanoate in t-butyl acetate polymerization initiator solution was injected. After 4 hours from the initiation of the polymerization, 24 ml of initiator solution had been injected, and the injection was stopped. The mixture temperature was slowly risen to 100° C. and kept there for 1 hr. Afterward, the mixture in the autoclave was lowered to room temperature, purged with nitrogen to remove unreacted monomers, and the system was brought to atmospheric pressure.

The resulting phosphoric ester functional fluorocopolymer solution in t-butyl acetate was removed from the autoclave. 1,652 g of phosphorus-containing fluorocopolymer solution was recovered.

From the results of NMR and infrared absorption spectrum analysis, the phosphorus-containing functional fluorocopolymer has random sequences of repeating units based on 3,3,3-trifluoropropene/repeating units based on ten-butyl acrylate/repeating units based on (dimethoxyphosphonoxy)ethyl acrylate: 50/43/7 (mol %). The solids percentage was 51%. The VOC of the phosphorus-containing functional fluorocopolymer solution was 0 g/L.

### Example 4

### Sequential Synthesis, Step 1

The polymerization autoclave used in Example 1 was pre-dried. The autoclave was charged with 800 g of tert-butyl acetate, 384 g (3.0 mol) of vinyl pivalate, 144 g (1.0 mol) of hydroxybutyl acrylate, and 0.46 g (2E-3 mol) of t-amyl peroxy-2-ethylhaxanoate. The autoclave was deaerated with nitrogen. The autoclave was charged with chlorotrifluoroethylene (CTFE) under 2 Bars pressure. The mixture in the autoclave was heated to 96° C. and charged with CTFE to raise the pressure to 4 Bars. The polymer initiator solution, 1 ml 0.017M of t-amyl peroxy-2-ethylhaxanoate in t-butyl acetate solution containing 3.03 g/L of t-amyl peroxy-2-ethylhanoate, was injected into the autoclave to initiate polymerization. Every 10 minutes thereafter, 1 ml of the 0.017M t-amyl peroxy-2-ethylhaxanoate in t-butyl acetate polymerization initiator solution was injected. Furthermore, CTFE was continuously charged to maintain the pressure at 4 Bars during the polymerization and the consumption of CTFE was recorded. After 5 hours from the initiation of the polymerization, a total of 473 g (4.06 mmol) of CTFE was charged and both the initiator solution and CTFE supply were stopped. The mixture temperature was slowly risen to 105° C. and kept there for 1 hr. Afterward, the mixture in the autoclave was lowered to room temperature and then purged with nitrogen to remove unreacted monomers, and the system was brought to atmospheric pressure.

The resulting hydroxy functional fluorocopolymer in tert-butyl acetate solution was removed from the autoclave. 1,813 g of hydroxy functional fluorocopolymer solution was recovered.

From the results of NMR and infrared absorption spectrum analysis, the hydroxy functional fluorocopolymer has random sequences of repeating units based on CTFE/repeating units based on vinyl pivalate/repeating units based on hydroxybutyl acrylate: 50/37.5/12.5 (mol %). The solids percentage was 54.5%. The hydroxyl value is 56 mg KOH/g. The VOC is 0 g/L.

### Example 5

### Sequential Synthesis, Step 1

Polymerization autoclave used in Example 1 was pre-dried. The autoclave was charged with 900 g of tert-butyl acetate, 297 g (1.5 mol) of vinyl ester versatic acid 10 (VeoVa 10), 276 g (1.5 mol) of vinyl versatic acid 9 (VeoVa 9), 87 g (0.75 mol) of hydroxypropyl vinyl ether, and 0.46 g (2E-3 mol) of t-amyl peroxy-2-ethylhaxanoate. The autoclave was deaerated with nitrogen. Then, autoclave was charged with tetrafluoroethylene (TFE) containing 0.5% propane under 2 Bars pressure. The mixture in the autoclave was heated to 96° C. and charged with TFE containing 0.5% propane to raise the pressure to 3 Bars. The polymer initiator solution, 1 ml 0.017M of t-amyl peroxy-2-ethylhaxanoate in t-butyl acetate solution containing 3.03 g/L of t-amyl peroxy-2-ethylhanoate, was injected into the autoclave to initiate polymerization. Every 10 minutes thereafter, 1 ml of the 0.017M t-amyl peroxy-2-ethylhaxanoate in t-butyl acetate polymerization initiator solution was injected. Furthermore, TFE containing 0.5% propane was continuously charged in order to maintain the pressure at 3 Bars during the polymerization and the consumption of TFE was recorded. After 5 hours from the initiation of the polymerization, a total of 383 g (3.83 mol) of TFE was charged, and both the initiator solution and TFE supply were stopped. The mixture temperature was slowly risen to 105° C. and kept there for 1 hr. Afterward, the mixture in the autoclave was lowered to room temperature and then purged with nitrogen to remove unreacted monomers, and the system was brought to atmospheric pressure.

The resulting phosphonic ester functional fluorocopolymer in t-butyl acetate solution was removed from the autoclave. 1,992 g of hydroxy functional fluorocopolymer solution was recovered.

From the results of NMR and infrared absorption spectrum analysis, the hydroxy functional fluorocopolymer has random sequences of repeating units based on TFE/repeating units based on vinyl versatate/repeating units based on hydroxybutyl vinyl ether: 50/40/10 (mol %). The solids percentage was 53%, the hydroxyl value is 40 mg KOH/g. The VOC is 0 g/L.

### Example 6

### Sequential Synthesis, Step 1

Polymerization autoclave used in Example 1 was pre-dried. The autoclave was charged with 900 g of tert-butyl acetate, 594 g (3.0 mol) of vinyl ester versatate VeoVa 10), 87 g (0.85 mol) of hydroxypropyl vinyl ether, 4.8 g of tertaethylthivam disulfide as chain transfer agent, and 0.46 g (2E-3 mol) of t-amyl peroxy-2-ethylhaxanoate. The autoclave was deaerated with nitrogen and tetrafluoroethylene. Then the autoclave was charged with tetrafluoroethylene (TFE) under 2 Bars pressure. The mixture in the autoclave was heated to 96° C. and charged with TFE to raise the pressure to 4 Bars. The polymer initiator solution, 1 ml 0.017M of t-amyl peroxy-2-ethylhaxanoate in t-amyl acetate solution containing 3.03 g/L of t-amyl peroxy-2-ethylhanoate, was injected into the autoclave to initiate polymerization. Every 10 minutes thereafter, 1 ml of the 0.017M t-amyl peroxy-2-ethylhaxanoate in t-amyl acetate polymerization initiator solution was injected. Further, TFE was continuously charged in order to maintain the pressure at 4 Bars during the polymerization and the consumption of TFE was recorded. After 5 hours from the initiation of the polymerization, a total of 395 g (3.95 mol) of TFE was charged, and both the initiator solution and the TFE supply were stopped.

The mixture temperature was slowly risen to 105° C. and kept there for 1 hr. Afterward, the mixture in the autoclave was lowered to room temperature and then purged with nitrogen to remove unreacted monomers, and the system was brought to atmospheric pressure.

The obtained hydroxy functional fluorocopolymer in t-butyl acetate solution was removed from the autoclave. 1,980 g of hydroxy functional fluorocopolymer solution was recovered.

From the results of NMR and infrared absorption spectrum analysis, the phosphorus-containing functional fluorocopolymer has random sequences of repeating units based on TFE/repeating units based on vinyl versatate/repeating units based on hydroxypropyl vinyl ether: 50/39/11 (mol %). The solids percentage was 53%, the hydroxyl value is 45 mg KOH/g. The VOC is 1.5 g/L.

### Example 7

### Sequential Synthesis, Step 2

450 g of tert-butyl acetate and 772 g of hydroxy functional fluorinated copolymer in tert-butyl acetate solvent obtained by Example 6 (53% solid, hydroxyl value 45 mg KOH/g) were charged into a 2,000 ml four-neck round-bottom flask equipped with turbine stirrer, thermometer, condenser, powder dispensing funnel, and heating mantle. 15.3 g (0.054 mol) of tetraphosphorus decaoxide (phosphorus pentoxide, P₄O₁₀) was added into the flask and vigorously stirred for 30 minutes. Using a powder dispensing funnel, 50 g of tert-butyl acetate was flushed into the flask. Under vigorous stirring, the mixture in the flask was heated from room temperature to 50° C. and kept under 50° C. for 26 hrs. Afterward, the temperature of the system was reduced to room temperature. The resulting content was removed from the flask and weighed. A total 1,228 g of phosphoric acid functional fluorocopolymer in tert-butyl acetate solution was obtained. The phosphorus-containing functional fluorocopolymer has random sequences of repeating units based on TFE/repeating units based on vinyl versatate/repeating units based on vinyloxypropyl phosphoric acid: 50/39/11 (mol %). The solids contents were 33%, and acid value 90 mg KOH/g). The VOC is 1.1 g/L.

### Example 8

### Sequential Synthesis, Step 3

500 g of phosphoric acid functional fluorocopolymer in tert-butyl acetate obtained in Example 7 (33% solid, acid value 90 mg KOH/g) was charged into a 1,000 ml four-neck round-bottom flask equipped with stirrer, thermometer, condenser, cylindrical funnel, and cooling bath. The content was cooled to 0° C. 20.0 g (0.27 mol) of diethylamine was dropped into the flask and vigorously stirred under 0° C. 514 g of phosphoric amide functional fluorocopolymer in t-butyl acetate was obtained. The phosphorus-containing functional fluorocopolymer has random sequences of repeating units based on TFE/repeating units based on vinyl versatate/repeating units based on vinyloxypropyl phosphoric acid diethylamide: 50/39/11 (mol %). The solids contents were 33%. The VOC is 1.0 g/L.

### Example 9

### Sequential Synthesis, Step 2

300 g of tert-butyl acetate, 400 g of hydroxy functional fluorocopolymer in tert-butyl acetate obtained in Example 4 (54.5% solid, hydroxyl value 56 mg KOH/g), and 24 g (0.23 mol) of triethylamine was charged into a 1,000 ml four-neck round-bottom flask equipped with stirrer, thermometer, condenser, cylindrical funnel, and cooling bath. The content was cooled to −15° C. After 1 hr, 41.5 g (0.22 mol) of dimethyl chlorothiophosphate was dropped into the flask and vigorously stirred under −15° C. The content of the flask was filtrated by vacuum through a glass filter to remove triethylamine chloride. The filtrated deposit was washed three times with a total of 90 g of tert-butyl acetate. 776 g of phosphorus-containing functional copolymer in tert-butyl acetate was obtained. The phosphorus-containing functional fluorocopolymer has random sequences of repeating units based on CTFE/repeating units based on vinyl pivalate/repeating units based on acryloylbutyl thiophosphoric acid diethyl ester: 50/37.5/12.5 (mol %). The solids contents were 30%. The VOC is 3.5 g/L.

What is claimed is:

1. A linear phosphorus-containing fluorinated copolymer comprising of:
(1a) copolymerized units of an oleophobic monomer, said oleophobic monomer being a fluoroolefin,
(1b) copolymerized units of an oleophilic monomer, said oleophilic monomer being an aliphatic or cycloaliphatic oxygen-containing functional monomer, and
(1c) copolymerized units of a metal bonding site monomer, said metal bonding site monomer being an unsaturated phosphorus derivative of a vinyl or vinylene group-containing monomer.

2. A linear phosphorus-containing fluorinated copolymer of claim 1 wherein said oleophobic monomer being a fluoroolefin is selected from the group consisting of tetrafluoroethylene, hexafluoropropylene, hexafluoroisobutylene, chlorotrifluoroethylene, vinylidene fluoride, difluoroethylene, trifluoroethylene, 3,3,3-trifluoropropene, 2,3,3,3-tetrafluoropropene, 1,2,3,3,3-pentafluoropropene, fluoroalkyl vinyl ether, hydropentafluoropropylene, perfluoromethyl vinyl ether, perfluoropropyl vinyl ether, and a mixture thereof.

3. A linear phosphorus-containing fluorinated copolymer of claim 1 wherein said oleophilic monomer being an aliphatic or cycloaliphatic oxygen-containing functional monomer is selected from the group consisting of:
(3a) vinyl ether selected from the group consisting of ethyl vinyl ether, iso-butyl vinyl ether, n-butyl vinyl ether, tert-butyl vinyl ether, cyclohexyl vinyl ether, dodecyl vinyl ether, octadecyl vinyl ether, iso-propyl vinyl ether, tert-amyl vinyl ether, triethylene glycol methyl vinyl ether, 2-ethyl hexyl vinyl ether, ethylene glycol butyl vinyl ether, 2-propyl heptanol vinyl ether, adamantyl vinyl ether, norbonyl vinyl ether, dihydrofurane, dihydropyran, and a mixture thereof,
(3b) vinyl ester selected from the group consisting of vinyl acetate, vinyl cyclohexanecarboxylic acid ester, vinyl neodecanoate, vinyl propionate, vinyl butanate, vinyl isobutyrate, vinyl 2-methyl propanoate, vinyl tert-butyrate, vinyl isovalerate, vinyl 3-methyl butyrate, vinyl versatate, vinyl isobutyrate, vinyl pivalate, vinyl caproate, vinyl 2-methyl pentanoate, vinyl trifluoroacetate, and a mixture thereof,
(3c) acrylate selected from the group consisting of methyl acrylate, ethyl acrylate, propyl acrylate, butyl acrylate, iso-butyl acrylate, tert-butyl acrylate, amyl acrylate, tert-amyl acrylate, 2-ethylhexyl acrylate, lauryl acrylate, cyclohexyl acrylate, stearyl acrylate, methyl methacrylate, ethyl methacrylate, propyl methacrylate, butyl methacrylate, iso-butyl methacrylate, tert-butyl methacrylate, amyl methacrylate, tert-amyl methacrylate, 2-ethylhexyl methacrylate, lauryl methacrylate, cyclohexyl methacrylate, stearyl methacrylate, and a mixture thereof,
(3d) vinyl carbonate selected from the group consisting of 1,3-vinyl-dioxolan-2-one, vinylene carbonate, and a mixture thereof,
(3e) vinyl anhydride selected from the group consisting of maleic anhydride, itaconic anhydride, citraconic anhydride, and a mixture thereof, and a mixture thereof,
(3f) functional cyclic monomer selected from the group consisting of dihydrofuran, 3,4-dihydro-2H-pyran, oxanorburnene, and a mixture thereof.

4. A linear phosphorus-containing fluorinated copolymer of claim 1 wherein said metal bonding site monomer being an unsaturated phosphorus derivative of a vinyl or vinylene group-containing monomer is selected from the group consisting of vinyl ether derivative of phosphoric acid, vinyl ester derivative of phosphoric acid, vinyl formate derivative of phosphoric acid, acrylate derivative of phosphoric acid, vinyl ether derivative of phosphonic acid, vinyl ester derivative of phosphonic acid, vinyl formate derivative of phosphonic acid, acrylate derivative of phosphonic acid, vinyl ether derivative of thiophosphoric acid, vinyl ester derivative of thiophosphoric acid, vinyl formate derivative of thiophosphoric acid, acrylate derivative of thiophosphoric acid, vinyl ether derivative of thiophosphonic acid, vinyl ester derivative of thiophosphonic acid, vinyl formate derivative of thiophosphonic acid, acrylate derivative of thiophosphonic acid, vinyl ether derivative of dithiophosphoric acid, vinyl ester derivative of dithiophosphoric acid, vinyl formate derivative of dithiophosphoric acid, acrylate derivative of dithiophosphoric acid, vinyl ether derivative of dithiophosphonic acid, vinyl ester derivative of dithiophosphonic acid, vinyl formate derivative of dithiophosphonic acid, acrylate derivative of dithiophosphonic acid, and a mixture thereof.

5. A linear phosphorus-containing fluorinated copolymer of claim 4 wherein said unsaturated phosphorus derivative of a vinyl or vinylene group-containing monomer is selected from the group consisting of vinylphosphonic acid dimethyl ester, vinylphosphonic acid diethyl ester, vinyloxycarbonyl phosphonic acid dimethyl ester, vinyloxycarbonyl phosphonic acid diethyl ester, vinyloxybutylcarbonyl phosphoric dimethyl ester, vinyloxybutylcarbonyl phosphoric diethyl ester, vinyloxybutyl phosphoric dimethyl ester, vinyloxybutyl phosphoric diethyl ester, acryloyl dimethyl phosphate, acryloyl diethyl phosphate, 2-(acryloyloxy)ethyl phosphonic dimethyl ester, 2-(acryloyloxy)ethyl phosphonic diethyl ester, dimethoxyphosphonoxy butyl prop-2-enoate, diethyoxyphosphooxy butyl prop-2-enoate, 1-vinyl-2-ethyoxy phosphoric dimethyl ester, 1-vinyl-2-ethyoxyl phosphoric diethyl ester, 1-vinyl-2-(ethyoxy)ethyl phosphoric dimethyl ester, 1-vinyl-2-(ethyoxy)ethyl phosphoric diethyl ester, 1-vinyl-2-(ethyoxy ethyoxy)ethyl phosphoric dimethyl ester, 1-vinyl-2-(ethyoxy ethyoxy)ethyl phosphoric diethyl ester, 1-[(dimethoxyphosphoryl)oxy]ethyl prop-2-enoate, 1-[(dimethoxyphosphoryl)oxy]propyl prop-2-enoate, 1-[(dimethoxyphosphoryl)oxy]butyl prop-2-enoate, 1-[(diethoxyphosphoryl)oxy]ethyl prop-2-enoate, 1-[(diethoxyphosphoryl)oxy]propyl prop-2-enoate, 1-[(diethoxyphosphoryl)oxy]butyl prop-2-enoate, 2-(omega-phosphonooxy-2-oxapropyl)acrylate, 2-(omega-phosphonooxy-2-oxaethyl)acrylate, and a mixture thereof.

6. A linear phosphorus-containing fluorinated copolymer of claim 1 wherein polymerization of said linear phosphorus-containing fluorinated copolymer is initialized with a radical initiator selected from tert-amyl peroxides.

7. A composition of claim 1 further comprising of tert-butyl acetate as a solvent.

8. Composition of claim 7 further comprising of a reaction product formed with a basic reactant selected from the group consisting of ammonia, aliphatic amine, cyclic aliphatic amine, n-methylpyrrolidone, and a mixture thereof.

9. An ingredient of a lubricant additive exhibiting friction reduction, viscosity modification, anti-wear, and corrosion protection characteristics wherein the ingredient has composition of claim 8.

10. A linear phosphorus-containing fluorinated copolymer comprising of a reaction product between:
(10a) a hydroxy functional fluorinated copolymer and
(10b) a phosphorus-containing reactant.

11. A linear phosphorus-containing fluorinated copolymer of claim 10 wherein said hydroxyl functional fluorinated copolymer is comprised of:
(11a) copolymerized units of an oleophobic monomer, said oleophobic monomer being a fluoroolefin,
(11b) copolymerized units of an oleophilic monomer, said oleophilic monomer being an aliphatic or cycloaliphatic oxygen-containing functional monomer, and
(11c) copolymerized units of a hydroxy-containing functional monomer.

12. A linear phosphorus-containing fluorinated copolymer of claim 11 wherein said oleophobic monomer being a fluoroolefin is selected from the group consisting of tetrafluoroethylene, hexafluoropropylene, hexafluoroisobutylene, chlorotrifluoroethylene, vinylidene fluoride, difluoroethylene, trifluoroethylene, 3,3,3-trifluoropropene, 2,3,3,3-tetrafluoropropene, 1,2,3,3,3-pentafluoropropene, fluoroalkyl vinyl ether, hydropentafluoropropylene, perfluoromethyl vinyl ether, perfluoropropyl vinyl ether, and a mixture thereof.

13. A linear phosphorus-containing fluorinated copolymer of claim 11 wherein said oleophilic monomer being an aliphatic or cycloaliphatic oxygen-containing functional monomer is selected from the group consisting of:
(13a) vinyl ether selected from the group consisting of ethyl vinyl ether, iso-butyl vinyl ether, n-butyl vinyl ether, tert-butyl vinyl ether, cyclohexyl vinyl ether, dodecyl vinyl ether, octadecyl vinyl ether, iso-propyl vinyl ether, tert-amyl vinyl ether, triethylene glycol methyl vinyl ether, 2-ethyl hexyl vinyl ether, ethylene glycol butyl vinyl ether, 2-propyl heptanol vinyl ether, adamantyl vinyl ether, norbonyl vinyl ether, dihydrofurane, dihydropyran, and a mixture thereof,
(13b) vinyl ester selected from the group consisting of vinyl acetate, vinyl cyclohexanecarboxylic acid ester, vinyl neodecanoate, vinyl propionate, vinyl butanate, vinyl isobutyrate, vinyl 2-methyl propanoate, vinyl tert-butyrate, vinyl isovalerate, vinyl 3-methyl butyrate, vinyl versatate, vinyl isobutyrate, vinyl pivalate, vinyl caproate, vinyl 2-methyl pentanoate, vinyl trifluoroacetate, and a mixture thereof,
(13c) acrylate selected from the group consisting of methyl acrylate, ethyl acrylate, propyl acrylate, butyl acrylate, iso-butyl acrylate, tert-butyl acrylate, amyl acrylate, tert-amyl acrylate, 2-ethylhexyl acrylate, lauryl acrylate, cyclohexyl acrylate, stearyl acrylate, methyl methacrylate, ethyl methacrylate, propyl methacrylate, butyl methacrylate, iso-butyl methacrylate, tert-butyl methacrylate, amyl methacrylate, tert-amyl methacrylate, 2-ethylhexyl methacrylate, lauryl methacrylate, cyclohexyl methacrylate, stearyl methacrylate, and a mixture thereof,
(13d) vinyl carbonate selected from the group consisting of 1,3vinyl-dioxolan-2-one, vinylene carbonate, and a mixture thereof,
(13e) vinyl anhydride selected from the group consisting of maleic anhydride, itaconic anhydride, citraconic anhydride, and a mixture thereof, and
(13f) functional cyclic monomer selected from the group consisting of dihydrofuran, 3,4-dihydro-2H-pyran, oxanorburnene, and a mixture thereof.

14. A linear phosphorus-containing fluorinated copolymer of claim 11 wherein said hydroxy-containing functional monomer is selected from the group consisting of hydroxybutyl vinyl ether, diethylene glycol monovinyl ether, 4-(hydroxymethyl)cyclohexyl methyl vinyl ether, hydroxyethyl acrylate, hydroxypropyl acrylate, hydroxybutyl acrylate, 2-ethyl hydroxyethyl acrylate, hydroxymethyl-cyclohexyl acrylate, hydroxyethyl methacrylate, hydroxypropyl methacrylate, hydroxybutyl methacrylate, 2-ethyl hydroxyethyl methacrylate, butanediol monoacrylate, hydroxybutyric acid vinyl ester, hydroxydecanoic acid vinyl ester, hydroxydodecanoic acid vinyl ester, hydroxyhaxadecanoic acid vinyl ester, hydroxyhexanoic acid vinyl ester, and a mixture thereof.

15. A linear phosphorus-containing fluorinated copolymer of claim 11 wherein polymerization of said hydroxy-containing functional polymer is initialized by a radical initiator selected from tert-amyl peroxides.

16. A linear phosphorus-containing fluorinated copolymer of claim 10 wherein said phosphorus-containing reactant is selected from the group consisting of tetraphosphorus decaoxide (P₄O₁₀), tetraphosphorus hexaoxide tetrasulfide (P₄O₆S₄), tetraphosphorus decasulfide (P₄S₁₀), dialkyl phosphinic chloride, dialkyl phosphonic chloride, dialkyl phosphoric chloride, trialkyl phosphoric ester, O,O-dialkyl thiophosphoryl chloride, dialkyl thiophosphonic chloride, dialkyl phosphodithioic chloride, and a mixture thereof.

17. Composition containing a linear phosphorus-containing fluorinated copolymer of claim 10.

18. A composition of claim 17 further comprising of tert-butyl acetate as solvent.

19. Composition of claim 17 further comprising of a reaction product formed with a basic reactant selected from the group consisting of ammonia, aliphatic amine, cyclo aliphatic amine, n-methylpyrrolidone and a mixture thereof.

20. An ingredient of a lubricant additive exhibiting friction reduction, viscosity modification, anti-wear, and corrosion protection characteristics wherein the ingredient has composition of claim 19.
